(19) United States
(12) Patent Application Publication
(10) Pub. No.: US 2021/0067788 A1
(43) Pub. Date: Mar. 4, 2021

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Masanobu Funakoshi, Yokohama-shi (JP)

(21) Appl. No.: 17/009,300

(22) Filed: Sep. 1, 2020

(30) Foreign Application Priority Data
Sep. 4, 2019 (JP) 2019-161285

(51) Int. Cl. H04N 19/18; H04N 19/17; H04N 19/61; H04N 9/804; H04N 21/8547

(52) U.S. Cl. CPC H04N 19/18; H04N 19/17; H04N 21/8547; H04N 9/8042; H04N 19/61

(57) ABSTRACT

An information processing apparatus includes an information obtaining unit configured to obtain information indicating a time code of a processing target video frame included in video data that is in accordance with a specific frame rate; a specifying unit configured to specify an acoustic signal block corresponding to the obtained time code among a plurality of acoustic signal blocks each of which collectively includes a fixed number of successive acoustic samples, the successive acoustic samples being included in acoustic data that is in accordance with a specific sampling rate, wherein a time interval corresponding to one video frame is different from a time interval corresponding to one acoustic signal block; and a processing unit configured to associate acoustic samples included in the specified acoustic signal block with the video frame corresponding to the obtained time code to perform processing.

### BACKGROUND OF THE INVENTION

### Field of the Invention

The present disclosure relates to a technique for processing an acoustic signal.

### Description of the Related Art

To enable reproduction of an acoustic signal in synchronization with another medium such as a video signal, a technique includes associating the acoustic signal with time information and providing the acoustic signal in a block form to store and extract the acoustic signal. As a method of providing an acoustic signal in the block form, there is a method of clipping an acoustic signal at the same time intervals as the time interval of 1 frame of a video signal to provide the acoustic signal in the block form.

Japanese Patent Laid-Open No. 2006-304304 discloses a method in which in a case where the number of acoustic signal samples corresponding to the period length of 1 frame of a video signal is a non-integer, the number of samples to be stored in an acoustic signal block is changed for each block.

However, in a case where the number of the samples is changed for each acoustic signal block as disclosed in Japanese Patent Laid-Open No. 2006-304304, it is impossible to process each acoustic signal block in the same manner, thus complicating acoustic processing. For example, in a case of performing time-frequency transformation such as FFT on an acoustic signal, the throughput of the acoustic processing may increase as a result of performing processing of converting the number of samples of an acoustic signal block from a variable length to a fixed length.

### SUMMARY OF THE INVENTION

An information processing apparatus in the present disclosure includes an information obtaining unit configured to obtain information indicating a time code of a processing target video frame included in video data that is in accordance with a specific frame rate; a specifying unit configured to specify an acoustic signal block corresponding to the obtained time code among a plurality of acoustic signal blocks each of which collectively includes a fixed number of successive acoustic samples, the successive acoustic samples being included in acoustic data that is in accordance with a specific sampling rate, wherein a time interval corresponding to one video frame is different from a time interval corresponding to one acoustic signal block; and a processing unit configured to associate acoustic samples included in the specified acoustic signal block with the video frame corresponding to the obtained time code to perform processing.

Further features of the present invention will become apparent from the following description of exemplary embodiments with reference to the attached drawings.

### BRIEF DESCRIPTION OF THE DRAWINGS

FIG. 1 shows a hardware configuration example of a video and acoustic signal blocks generation apparatus;

FIG. 2 shows a functional configuration example of the video and acoustic signal blocks generation apparatus;

FIG. 3 is a flowchart showing processing of generating video and acoustic signal blocks;

FIG. 4 is a flowchart showing time information determination processing;

FIG. 5 is a schematic diagram for illustrating an interval of acoustic signal block time;

FIG. 6 is a flowchart showing acoustic signal block generation processing;

FIG. 7 shows the data structure of an acoustic signal block;

FIG. 8 shows a functional configuration example of a video and acoustic signal blocks search apparatus;

FIG. 9 is a diagram showing the relationship of FIG. 9A and FIG. 9B;

FIG. 9A is a flowchart showing processing of searching for video and acoustic signal blocks;

FIG. 9B is a flowchart showing processing of searching for video and acoustic signal blocks;

FIG. 10 is a flowchart showing offset determination processing;

FIG. 11 is a schematic diagram for illustrating an offset; and

FIG. 12 shows a functional configuration example of a processing system for video and acoustic signal blocks.

### DESCRIPTION OF THE EMBODIMENTS

Hereinafter, embodiments will be described with reference to the drawings. Incidentally, configurations shown in the following embodiments are each merely an example, and the present invention is not limited to the configurations shown in the drawings. Additionally, all combinations of features described in the present embodiments are not necessarily essential to the solving means of the present invention. In addition, the same components will be described using the same reference numerals.

### First Embodiment

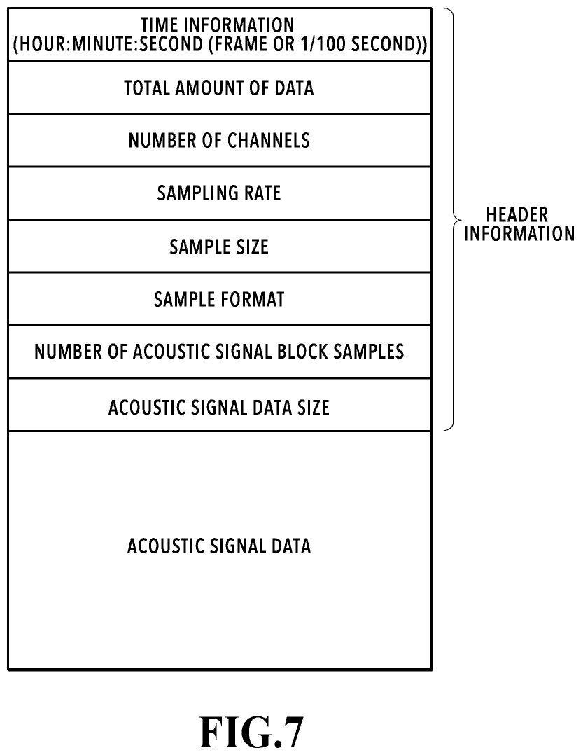

An acoustic signal block in the present embodiment is a block that stores header information including time information and the like and a sampled acoustic signal corresponding to the predetermined number of samples (acoustic signal samples) (see FIG. 7). A description of FIG. 7 will be given later. In a case of recording a video signal and an acoustic signal so that video and audio can be reproduced together, a conceivable way is, for example, to generate an acoustic signal block storing a certain number of acoustic signal samples corresponding to unit frame time of the video signal. A video signal frame and an acoustic signal block corresponding to the frame are processed simultaneously and outputted, thereby enabling reproduction of video and audio with their timings matching appropriately. A video signal is, for example, data based on imaging of an imaging target region. An acoustic signal is, for example, data based on sound collection in the imaging target region.

Here, in a case where an acoustic signal block is generated in a frame time unit of a video signal, the number of acoustic signal samples to be stored in one block (sample number) is calculated by dividing an acoustic signal sampling rate by a video signal frame rate. However, there is a case where the acoustic signal sampling rate is not an integral multiple of the video signal frame rate. Hereinafter, a description will be given of a method in which in such a case, an acoustic signal block is generated in a predetermined block time unit not identical to the unit frame time and also video and audio can be reproduced with their timings matching appropriately.

Incidentally, the content of a sound represented by an acoustic signal is not limited to a specific sound among human voice, the sounds of nature, noise, undesired sounds, or the like. In the present embodiment, a description will be given on the premise that a processing target acoustic signal represents a sound recorded together with video in a case of capturing a moving image.

### [Hardware Configuration]

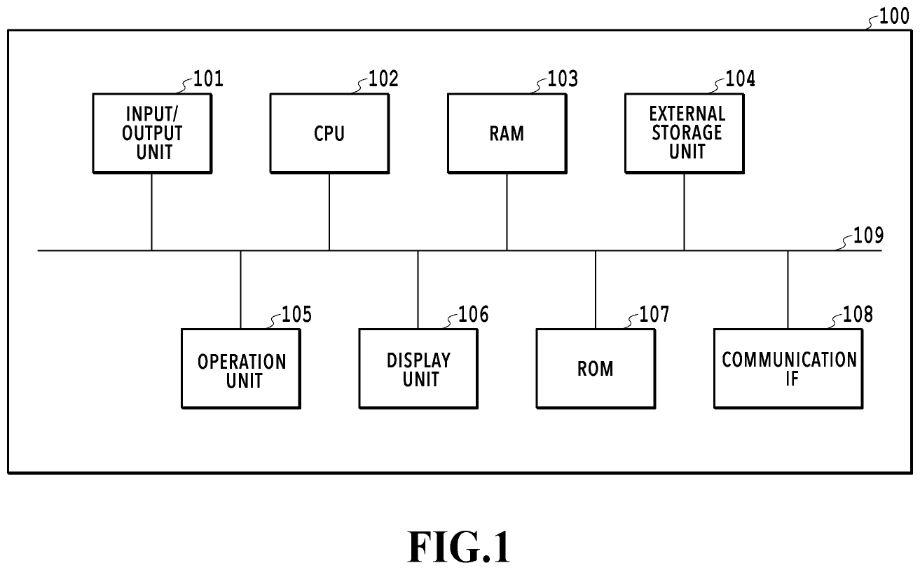

FIG. 1 shows an example of the hardware configuration of a video and acoustic signal blocks generation apparatus 100 (hereinafter referred to as the blocks generation apparatus) that is an information processing apparatus according to the present embodiment. The blocks generation apparatus 100 includes an input/output unit 101, a CPU 102, a ROM 107, a RAM 103, an external storage unit 104, a display unit 106, an operation unit 105, a communication IF 108, and a bus 109.

The input/output unit 101 receives input of a video signal, an acoustic signal, and a time code from the outside and performs transmission to another component via the bus 109 in accordance with instructions of the CPU 102.

The CPU 102 is a processor that uses the RAM 103 as a work memory to execute a program stored in the ROM 107 and exercises overall control over the individual component units of the blocks generation apparatus 100. In accordance with a control signal from the operation unit 105, the CPU 102 controls a program under execution and provides instructions to control other components.

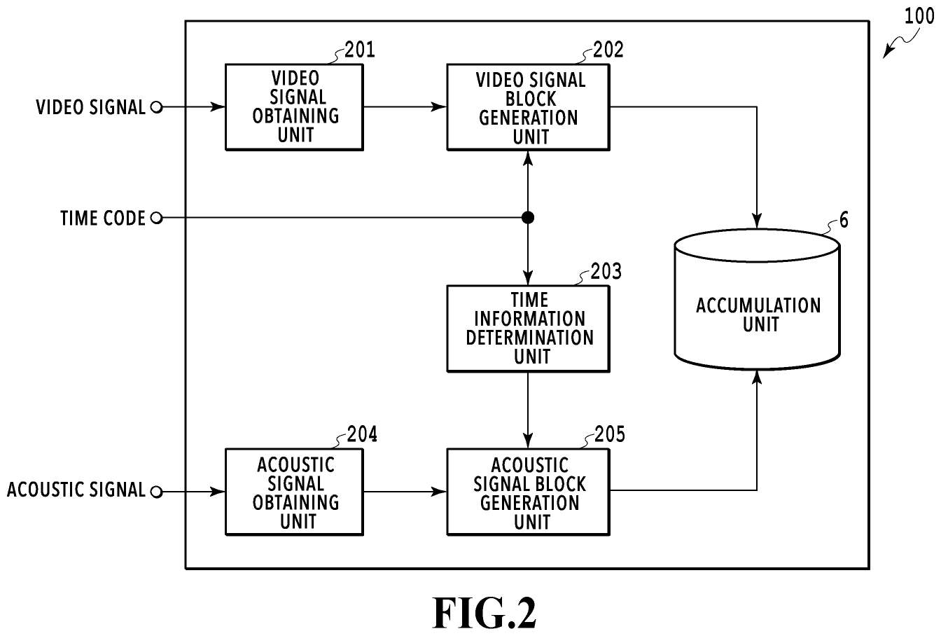

The CPU 102 controls the whole of the blocks generation apparatus 100 to thereby achieve the individual units of the blocks generation apparatus 100 shown in FIG. 2 to be described later. Incidentally, the blocks generation apparatus 100 may include one or more pieces of dedicated hardware differing from the CPU 102. Additionally, the dedicated hardware may execute at least part of processing by the CPU 102. Examples of the dedicated hardware are an application specific integrated circuit (ASIC), a field programmable gate array (FPGA), and a digital signal processor (DSP), for example.

The RAM 103 temporarily stores part of a program under execution, associated data, and results of calculations by the CPU 102, for example. The external storage unit 104 is a storage unit achieved by an HDD, an SSD, or the like. The external storage unit 104 stores the body of a program and data to be accumulated for a long period.

The operation unit 105 receives various kinds of instruction operation from a user, converts the operation into a control signal, and transmits the signal via the bus 109 to the CPU 102. The display unit 106 displays, for the user, the state of a program under execution and output of the program. In the present embodiment, although the display unit 106 and the operation unit 105 exist inside the blocks generation apparatus 100, at least one of the display unit 106 and the operation unit 105 may exist as another apparatus outside the blocks generation apparatus 100. In this case, the CPU 102 may operate as a display control unit that controls the display unit 106 and an operation control unit that controls the operation unit 105.

The ROM 107 stores fixed programs and fixed parameters that do not need to be changed. For example, the ROM 107 stores a program for activating/deactivating the present hardware apparatus and a program that controls basic input/output.

The communication IF 108 is used for communication between the blocks generation apparatus 100 and an external apparatus. For example, in a case of making a wired connection of the blocks generation apparatus 100 to the external apparatus, a cable for communication is connected to the communication IF 108. In a case where the blocks generation apparatus 100 has the function of performing wireless communication with the external apparatus, the communication IF 108 includes an antenna.

### [Functional Configuration]

FIG. 2 shows an example of the functional configuration of the blocks generation apparatus 100 according to the present embodiment. The blocks generation apparatus 100 according to the present embodiment includes a video signal obtaining unit 201, a video signal block generation unit 202, a time information determination unit 203, an acoustic signal obtaining unit 204, and an acoustic signal block generation unit 205, and an accumulation unit 6. The blocks generation apparatus 100 according to the present embodiment functions as an acoustic signal block generation apparatus that generates acoustic signal blocks and a video signal block generation apparatus that generates video signal blocks.

The video signal obtaining unit 201 obtains a video signal inputted from the outside and outputs the signal to the video signal block generation unit 202. The video signal block generation unit 202 adds an inputted time code to generate data in the form of a block corresponding to 1 frame of the inputted video signal and output the data to the accumulation unit 6.

The time information determination unit 203 includes an obtaining unit that obtains a time code and a conversion unit that converts the obtained time code into time. Unlike the time code, the time refers to time not depending on a frame unit of a video signal. Additionally, the time information determination unit 203 determines the fixed number of samples of an acoustic signal block. Details of processing by the time information determination unit 203 will be described later.

The acoustic signal obtaining unit 204 obtains a sampled acoustic signal inputted from the outside and outputs the signal to the acoustic signal block generation unit 205.

The acoustic signal block generation unit 205 performs processing of clipping a predetermined sample number of acoustic signal samples according to a relationship between a frame rate and a sampling rate stored on the RAM 103. Additionally, the acoustic signal block generation unit 205 adds time information determined by the time information determination unit 203 and associates the acoustic signal with the time information to provide the acoustic signal in a block form, thereby generating data. The generated data on the acoustic signal block is outputted to the accumulation unit 6.

The functions of the above individual units are achieved by the CPU reading out, into the RAM, program code stored in the ROM or an external storage apparatus and executing the program code. Alternatively, some or all of the functions of the above individual units may be achieved by using hardware such as an ASIC or electronic circuit.

The accumulation unit 6 stores the video signal block generated by the video signal block generation unit 202 and the acoustic signal block generated by the acoustic signal block generation unit 205. The accumulation unit 6 is achieved by the external storage unit 104. Incidentally, in the present embodiment, although the accumulation unit 6 is included in the configuration of the blocks generation apparatus 100, the accumulation unit 6 may be achieved by, for example, a ROM or external storage unit in another apparatus differing from the blocks generation apparatus 100. In such a case, the blocks generation apparatus 100 is connected via a network or the like to an apparatus including an accumulation unit for storing the blocks.

### [Processing of Generating Video Signal Block and Acoustic Signal Block]

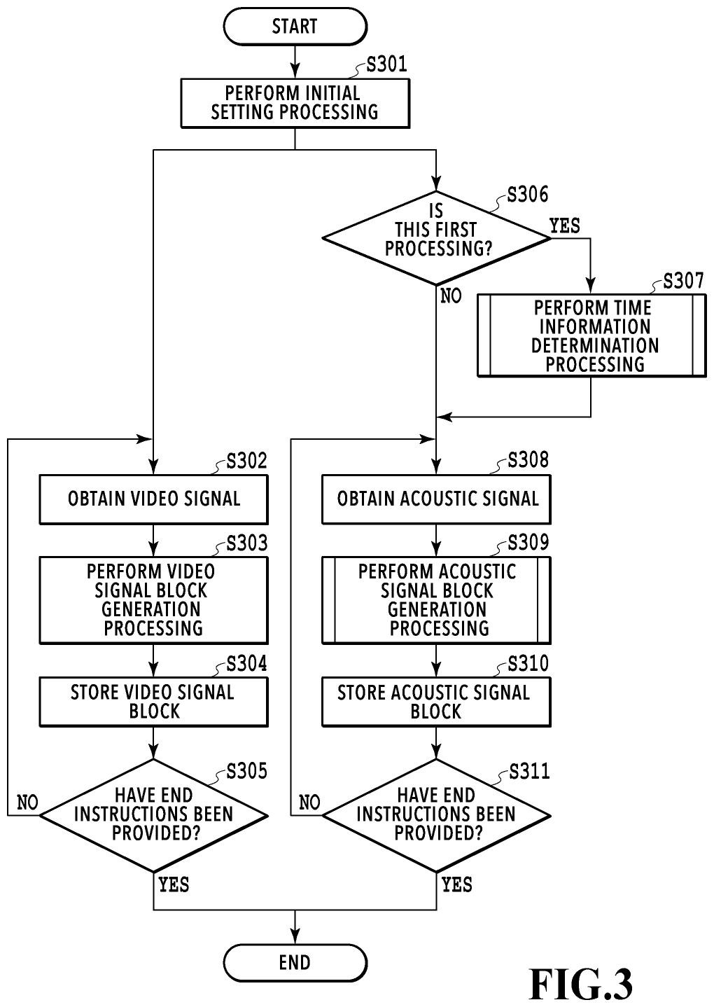

FIG. 3 is a flowchart for illustrating processing of generating a video signal block and an acoustic signal block in the present embodiment. A series of kinds of processing shown in the flowchart of FIG. 3 is performed by the CPU reading out, into the RAM, program code stored in the ROM and executing the program code. Additionally, some or all of the functions of steps in FIG. 3 may be achieved by using hardware such as an ASIC or electronic circuit. Incidentally, the symbol “S” in a description of each kind of processing means a “step” in the flowchart, and the same applies to subsequent flowcharts. A description will be given on the premise that the following processing in the flowcharts is processing of providing, in the block form, a video signal in a case of capturing a moving image and an acoustic signal of a sound recorded together with the video.

In S301, the CPU 102 performs initial setting processing. Various kinds of information to be subjected to the initial setting processing are information on a video frame rate, a video format, and the number of pixel bits and information on an acoustic sampling rate, an acoustic signal format, and a sample bit width, for example. In the initial setting processing, the CPU 102 determines the values of the various kinds of information based on default values stored on the ROM 107 or based on instructions provided by user operation from the operation unit. Subsequently, the determined values are transferred to and stored in a predetermined area on the RAM 103.

Processing of subsequent S302 to S305 is a flow for generating a video signal block. Additionally, processing of S306 to S311 is a flow for generating an acoustic signal block. In the present embodiment, video signal block generation processing and acoustic signal block generation processing are performed in parallel. Incidentally, in a case where real-time generation of a video signal block and an acoustic signal block is not performed together with imaging and sound collection but the video signal block and the acoustic signal block are generated from video data and acoustic data prestored in a predetermined storage unit, it is possible to complete the video signal block generation processing and then start the acoustic signal block generation processing. Alternatively, it is also possible to reverse the processing order. In such a case, by synchronization of initial time information (time codes) on a processing target video signal and a processing target acoustic signal, data on video and audio corresponding thereto in the same period can be generated. First, the video signal block generation processing of S302 to S305 will be described.

In S302, the video signal obtaining unit 201 obtains an inputted video signal and outputs the signal to the video signal block generation unit 202. In S303, the video signal block generation unit 202 associates video signal data corresponding to 1 frame of the video signal with header information and a time code and generates a video signal block. The video signal block generation unit 202 outputs the generated video signal block to the accumulation unit 6. In S304, the accumulation unit 6 stores the obtained video signal block in a form in which a search can be appropriately performed for a memory address within the accumulation unit 6.

In S305, it is determined whether the user's instructions to end the block generation processing have been provided. In a case where the user's end instructions have been provided via the operation unit 105, the video signal block generation processing ends. In a case where no end instructions have been provided, the processing returns to S302, a 1-frame advance is made for the time code, and the block generation processing is continued for a video signal of the subsequent frame.

Next, the acoustic signal block generation processing of S306 to S311 will be described.

In S306, the CPU 102 determines whether this is first processing. In a case of the first processing, the processing advances to S307.

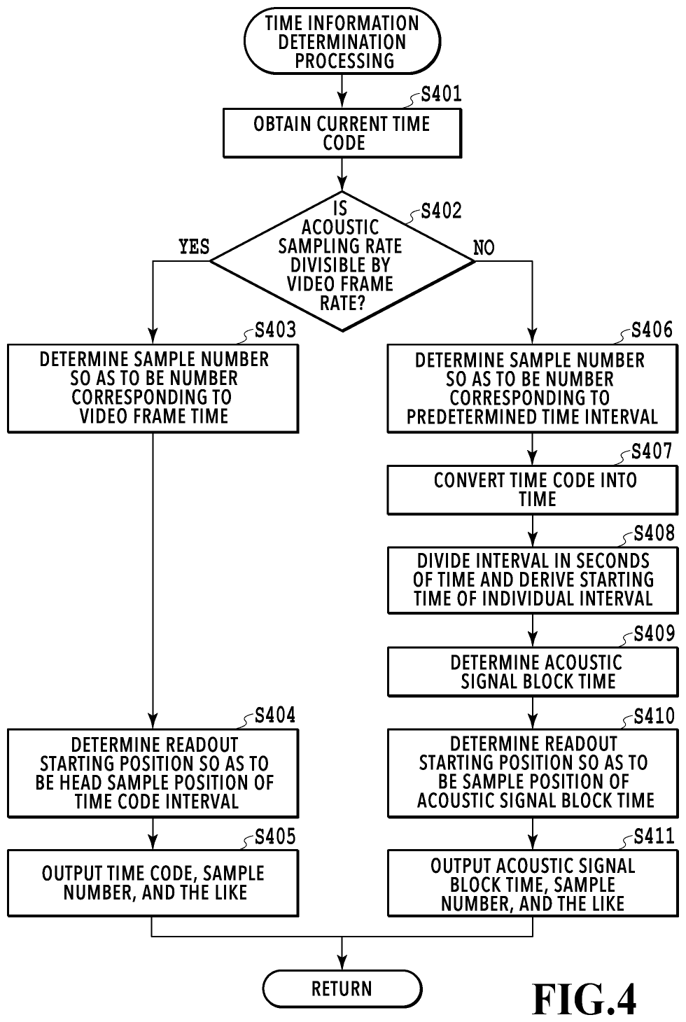

In S307, the time information determination unit 203 obtains a time code that is a processing target and performs time information determination processing for generating time information based on the time code. Details of the time information determination processing will be described later using FIG. 4. The generated time information is outputted to the acoustic signal block generation unit 205. In a case where the processing of S307 has ended or in a case where this is not the first processing, the procedure advances to S308.

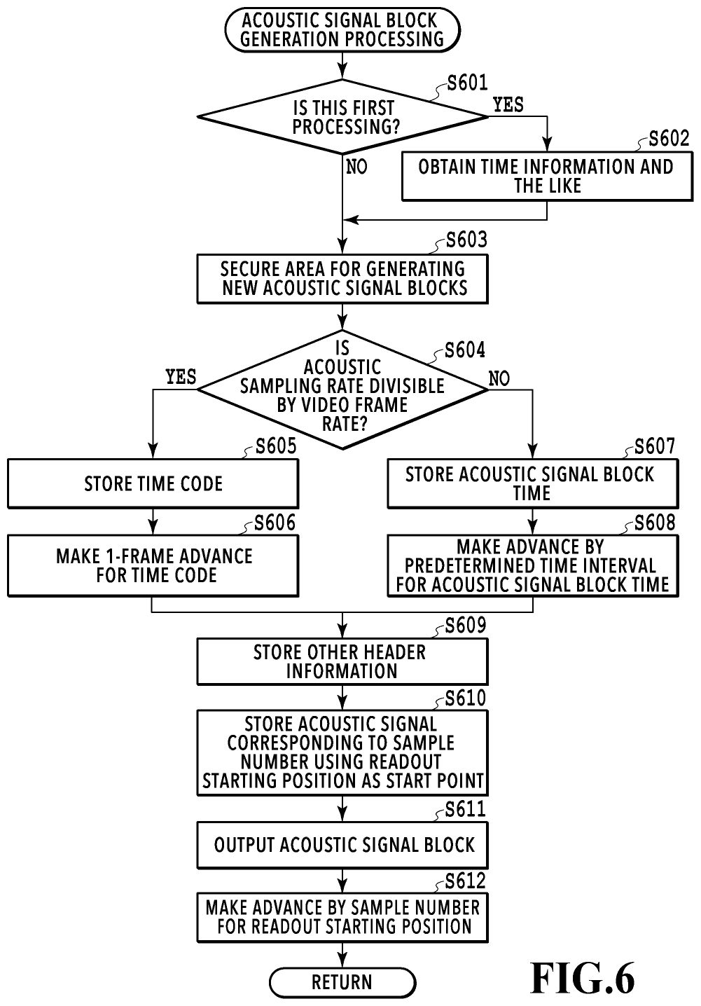

In S308, the acoustic signal obtaining unit 204 obtains an acoustic signal. In S309, the acoustic signal block generation unit 205 adds header information including time information to an acoustic signal corresponding to a sample number and performs the acoustic signal block generation processing for generating an acoustic signal block. Details of the acoustic signal block generation processing will be described later using FIG. 6.

In S310, the accumulation unit 6 stores the acoustic signal block in a form in which a search can be appropriately performed for a memory address within the accumulation unit 6. For example, the acoustic signal block is stored in a form to be described later using FIG. 7. Additionally, the acoustic signal block may be stored in a state where the block is associated with the video signal block stored in S304.

In S311, it is determined whether the user's instructions to end the block generation processing have been provided. In a case where the user's end instructions have been provided via the operation unit 105, the acoustic signal block generation processing ends. In a case where the user's end instructions have not been provided, the processing returns to S308 and the processing is continued for a subsequent acoustic signal.

### [Time Information Determination Processing]

FIG. 4 is a flowchart for illustrating details of the time information determination processing of S307.

In S401, the time information determination unit 203 obtains a current time code that is a processing target and stores the time code on the RAM.

In S402, the time information determination unit 203 determines whether a sampling rate that represents the number of samples per second of an acoustic signal is divisible by a frame rate that represents the number of frames per second of a video signal. In a case where a value obtained by dividing the sampling rate by the frame rate is an integer without a remainder, it is determined that the sampling rate is divisible. For the acoustic signal sampling rate and the video signal frame rate, values stored in the specified area on the RAM 103 by the initial setting processing of S301 are used.

In a case where the sampling rate is divisible by the frame rate (YES in S402), the procedure advances to S403 to perform processing for generating an acoustic signal block in a frame time unit in S403 to S405. In a case where the sampling rate is not divisible by the frame rate (NO in S402), the procedure advances to S406 to S411 to perform processing for generating an acoustic signal block in a predetermined time interval unit, not in the frame time unit.

First, the processing of S403 to S405 will be described. In S403, the time information determination unit 203 determines the number of acoustic signal samples to be stored in an acoustic signal block so that the number corresponds to frame time that is a time interval equivalent to 1 frame of a video signal. For example, the time information determination unit 203 determines, as the number of acoustic signal samples to be stored in an acoustic signal block, a number obtained as a result of dividing the acoustic signal sampling rate by the video signal frame rate.

For example, assuming that the frame rate is 25 fps and the sampling rate is 48,000 Hz, the number of samples to be stored in one acoustic signal block is determined as 1920. By using the fixed number of samples determined in this manner, an acoustic signal block corresponding to the frame time of a video signal is generated in subsequent acoustic signal block generation processing (S309).

In S404, the time information determination unit 203 determines, as a readout starting position for a sampled acoustic signal, a sample position at the head of the time code interval obtained in S401. The readout starting position is used to start acoustic signal block generation from the determined readout starting position in acoustic signal block generation processing to be described later.

In S405, the time information determination unit 203 outputs, to the acoustic signal block generation unit 205, the time code obtained in S401, the number of samples of an acoustic signal block determined in S402, and the readout starting position determined in S404. Upon completion of the processing, the time information determination processing ends.

Next, a description will be given of the processing in S406 to S411 in a case where the sampling rate is not divisible by the frame rate (NO in S402).

In S406, the time information determination unit 203 determines the sample number of acoustic signal samples to be stored in an acoustic signal block so as to be a number corresponding to the predetermined time interval set in advance. In a case where the sampling rate is not divisible by the frame rate, dividing the sampling rate by the frame rate to determine the sample number as described in S403 gives a remainder. Assuming that the sample number is set to a value differing for an individual acoustic signal block in order to adjust the remainder, the processing is complicated.

Thus, in the processing of S406, the number of samples to be stored in an acoustic signal block is set to the fixed number of samples not differing for an individual acoustic signal block. More specifically, in a case where the sampling rate is not divisible by the frame rate, acoustic signal blocks are generated at time intervals differing from the frame time. In the present step, the number of samples corresponding to a predetermined time interval is determined. The above fixed number of samples may be a number not depending on the frame rate.

The predetermined time interval, for example, has an interval length of time of 1 second or less and is a value that is set regardless of the video signal frame rate and predetermined according to the convenience of acoustic signal processing and time management, for example.

The predetermined time interval is defined, for example, as a time interval that is less than 1 second and is an integral multiple of 1/100 second in consideration of the convenience in managing time information to be described later. In the present embodiment, a description will be given on the premise that the predetermined time interval is an interval of 1/20 second ( 5/100 second), that is, 50 milliseconds.

For example, assuming that the video signal frame rate is 29.97 fps and the acoustic signal sampling rate is 48,000 Hz, the number of samples in frame time is 1601.601 . . . , which means that a remainder is given. In this case, if the number of samples is determined by using an interval of 1/20 second, which is the predetermined time interval, the acoustic signal sampling rate is 48,000 Hz and therefore, the number of samples is determined as a value without a remainder as shown in the expression 48,000× 1/20 second=2400.

In S407, the time information determination unit 203 converts the time code TC obtained in S401 into time T. The time code refers to time managed in a frame unit of a video signal. Meanwhile, the time T is not time as managed in the frame unit of the video signal but general time as represented in a unit of 1/100 second, for example.

In a method of converting the time code TC into the time T, for example, a reference time code TCo and reference time To such that the value in hours, minutes, and seconds of the time code TC matches the value in hours, minutes, and seconds of the time T are set. And then the number of frames fr of a video signal from the reference time code TCo to the time code TC to be converted into the time T is counted. And the number of frames fr is multiplied by video frame time Tf that is time per frame and the reference time To is added to the result, thereby the time T is derived. This is shown in the following expression:

T=To+fr×Tf

where fr=TC−TCo (1).

For example, it is assumed that the reference time code TCo is 01:00:00:00 and the reference time To is 01:00′00″00. In a case where the time code TC to be converted is 01:23:45:06 and the frame rate is 29.97 fps, the video frame time Tf is a reciprocal number of the frame rate and therefore, the time T obtained by the conversion is derived as follows:

T=01:00′00″00+(23×60×30+45×30+6)×1/29.97 second≈01:23′46″626626627 (2).

In S408, the time information determination unit 203 divides the interval in seconds of the time T derived in S407 by the predetermined time interval used in S406 and derives starting time of an individual interval.

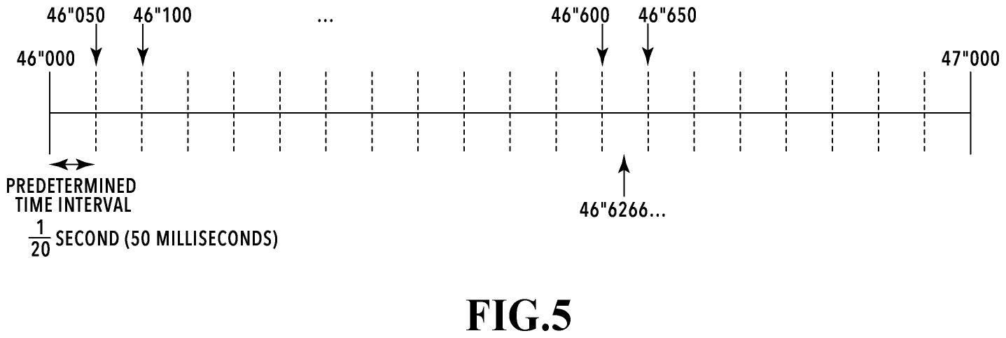

FIG. 5 is a diagram for illustrating an interval in seconds in a case where the predetermined time interval is an interval of 1/20 second. FIG. 5 shows an example in which 1 second from a base point of 46.00 seconds in the time T determined by using expression (2) is divided by the predetermined time interval. As shown with dotted lines in FIG. 5, the interval in seconds of the time T is equally divided by 1/20 second so as to be divided into 20 equal parts. Starting time of an individual interval (part delimited by dotted lines) can be derived as 46″000, 46″050, 46″100, . . . from the extreme left in FIG. 5.

In S409, the time information determination unit 203 determines, among the intervals obtained by the division in S408, an interval including the time T corresponding to the time code TC derived in S407 and determines the starting time of the interval as “acoustic signal block time.”

For example, in a case of the time T in expression (2) used in S407, the value in seconds and the subsequent value are expressed as 46″626626627 and therefore, the time T is included in an interval having starting time 46″600 as shown in FIG. 5. Since the starting time of the interval is 46″600, the “acoustic signal block time” is determined as 01:23′46″60.

In S410, the time information determination unit 203 determines, as a readout starting position, the sample position of an acoustic signal sample at the time of the “acoustic signal block time” determined in S409. In the acoustic signal block generation processing, a sample number of acoustic signal samples from the determined readout starting position are stored to generate an acoustic signal block. Thus, the “acoustic signal block time” is stored in the acoustic signal block as time corresponding to the earliest acoustic signal samples (head acoustic signal samples) of acoustic signal samples to be stored in acoustic signal blocks in subsequent acoustic signal block generation processing.

In S411, the time information determination unit 203 outputs, to the acoustic signal block generation unit 205, the acoustic signal block time determined in S409, the sample number for an acoustic signal block determined in S406, and the readout starting position for an acoustic signal determined in S410. Upon completion of the processing, the time information determination processing ends.

### [Acoustic Signal Block Generation Processing]

FIG. 6 is a flowchart for illustrating details of the acoustic signal block generation processing in the present embodiment. The processing in the present flowchart is performed in the acoustic signal block generation unit 205.

In S601, the acoustic signal block generation unit 205 determines whether this acoustic signal block generation processing is first processing. In a case of the first processing, the procedure advances to S602.

In S602, the acoustic signal block generation unit 205 obtains the time code or acoustic signal block time, the number of samples to be stored in an acoustic signal block, and the readout starting position outputted from the time information determination unit 203 in the time information determination processing (S307). The obtained individual pieces of information are stored in the specified area of the RAM 103. In a case where the processing of the present step ends, the procedure advances to S603.

In S603, the acoustic signal block generation unit 205 secures, on the RAM 103, an area for storing data on acoustic signal blocks.

FIG. 7 shows an example of the data structure of an acoustic signal block. As shown in FIG. 7, the acoustic signal block according to the present embodiment includes areas storing time information, the total amount of data, the number of channels, sample size, a sampling rate, a sample format, the number of acoustic signal block samples, acoustic signal data size, and acoustic signal data. The information other than the acoustic signal data is referred to as header information. In the present step, the areas for storing these pieces of data are secured.

Here, the time information refers to an area storing a time code or acoustic signal block time. As described later, the time code is stored in S605 and the acoustic signal block time is stored in S607. In a case where the time code is stored, time in hours, minutes, and seconds, and the number of frames are stored. In a case where the acoustic signal block time is stored, time in hours, minutes, and seconds and in a unit of 1/100 second as time less than a second is stored in an acoustic signal block.

In the present embodiment, a unit of time less than a second for the stored acoustic signal block time is set as a unit of 1/100 second. By setting the unit of time less than a second to the unit of 1/100 second, the range of a numerical value less than a second can be limited to 0 to 99. Thus, the time information corresponding to an acoustic signal can be stored in a data amount of 1 byte. Meanwhile, the number of frames of a time code corresponding to a video signal has the range of values 0 to 59 at the most. Thus, this can also be stored in a data amount of 1 byte. For this reason, by setting the unit of time less than a second for acoustic signal block time to the unit of 1/100 second, the acoustic signal block time can be represented like the time code. That is, it is possible to store time using the same data structure for the acoustic signal block time and the time code.

In S604, the acoustic signal block generation unit 205 determines whether the acoustic signal sampling rate is divisible by the video signal frame rate.

In a case where the sampling rate is divisible by the frame rate (YES in S604), the procedure advances to S605 to perform processing for generating an acoustic signal block in a frame time unit in S605 and S606. In a case where the sampling rate is not divisible by the frame rate (NO in S604), the procedure advances to S607 and S608 to perform processing for generating an acoustic signal block in a predetermined time unit, not in the frame time unit.

First, the processing of S605 and S606 will be described. In S605, the acoustic signal block generation unit 205 stores, in the time information of an acoustic signal block, the time code stored in the specified area of the RAM 103.

In S606, the acoustic signal block generation unit 205 makes a 1-frame advance for the time code on the RAM 103.

Next, the processing of S607 and S608 will be described. In a case where the acoustic signal sampling rate is not divisible by the video signal frame rate (NO in S604), the acoustic signal block generation unit 205 stores, in the time information of an acoustic signal block, the acoustic signal block time stored in the specified area of the RAM 103 in S607.

In S608, the acoustic signal block generation unit 205 makes an advance by the predetermined time interval for the acoustic signal block time on the RAM 103. That is, in the present embodiment, an advance by 1/20 second is made for the acoustic signal block time.

In S609, the acoustic signal block generation unit 205 stores data other than the time information in the header information of an acoustic signal block. More specifically, the acoustic signal block generation unit 205 stores, in the total amount of data, the size of the entire acoustic signal block including the header information. As the number of channels, the number of channels for acoustic signal data is stored. As the sampling rate, a sampling rate of the acoustic signal data is stored. As the sample size, the size of 1 acoustic signal sample is stored. As the sample format, information showing a format such as the bit width and the fixed point or floating point of a sampled acoustic signal is stored. As the number of acoustic signal block samples, the number of the samples per channel stored in the acoustic signal data is stored. As the acoustic signal data size, the size of the acoustic signal data is stored.

In S610, the acoustic signal block generation unit 205 uses, as a start point, the readout starting position obtained and stored in the specified area of the RAM 103 in S602 to store a sample number of acoustic signal samples for each channel in the acoustic signal data area of an acoustic signal block. That is, the acoustic signal samples in the predetermined time interval having, as a start point, the acoustic signal block time are stored to generate an acoustic signal block associated with the acoustic signal block time, which is the time of the start point. Through the present step, all information for the acoustic signal block is stored.

The sample number of the stored acoustic signal samples is a number determined in the time information determination processing. Even in a case where the acoustic signal sampling rate is not divisible by the video signal frame rate, the sample number is determined as a fixed value derived from the predetermined time interval. That is, the present embodiment is designed so that the number of samples stored in an acoustic signal block is always a fixed value. Thus, in a case of generation of a subsequent block based on a time code, a mere count-up operation by 1 frame from a previous time code makes it possible to derive a time code to be stored in the time information of a subsequent acoustic signal block. Additionally, in a case of generation of a subsequent block based on acoustic signal block time, a mere count-up operation by the predetermined time interval from previous acoustic signal block time makes it possible to derive time to be stored in the time information of the subsequent acoustic signal block. That is, it is only required that time information on a time code or acoustic signal block time be obtained in a case of the first processing.

In S611, the acoustic signal block generation unit 205 outputs a generated acoustic signal block to the accumulation unit 6.

In S612, the acoustic signal block generation unit 205 makes an advance for the readout starting position on the RAM 103 by the sample number determined in the time information determination processing. Upon completion of the processing in the present step, the acoustic signal block generation processing is ended.

Through the present step, a 1-frame advance is made for the readout starting position in a case where the acoustic signal sampling rate is divisible by the video signal frame rate. In a case where the acoustic signal sampling rate is not divisible by the video signal frame rate, an advance by the sample number corresponding to the predetermined time interval is made for the readout starting position. Thus, in a case of continuously generating a subsequent acoustic signal block that is an acoustic signal block at time for which an advance has been made by the predetermined time interval, it is possible to store acoustic signal samples continuously after an acoustic signal stored in the previously generated acoustic signal block.

Thus, in a case where the acoustic signal sampling rate is divisible by the video signal frame rate, an acoustic signal block is generated in each frame time unit. Additionally, in a case where the acoustic signal sampling rate is not divisible by the video signal frame rate, the block is generated in each predetermined time interval unit.

In a case where the acoustic signal sampling rate is not divisible by the video signal frame rate, each acoustic signal block is generated in the predetermined time interval unit such that the sample number has no remainder, not in the frame time unit. The acoustic signal block is preferably generated in a time interval unit by which 1 second is divisible as shown in FIG. 5. An interval is divided so as to be divisible by a predetermined time interval in a second unit, such as 1/20 second, thereby excluding an interval within which x.00 second is covered in a processing unit of an acoustic signal. That is, it is possible to generate acoustic signal blocks so that separations in seconds match separations of the acoustic signal blocks. It is also possible to extract or store an acoustic signal in the second unit in a case where successive acoustic signal blocks are collectively handled, thus enabling simple and easily comprehensible handling of the acoustic signal.

As described above, the present embodiment enables generation of acoustic signal blocks using the fixed sample number of acoustic signal samples to be stored even in a case where the acoustic signal sampling rate is not divisible by the video signal frame rate. Thus, handling of an acoustic signal is simplified, enabling the throughput of the acoustic processing to be reduced.

Incidentally, in the above description, acoustic signal blocks have been described as being generated at predetermined time intervals in a case where the acoustic signal sampling rate is not divisible by the video signal frame rate. In addition to this, acoustic signal blocks may be generated in the predetermined time interval unit regardless of whether the acoustic signal sampling rate is divisible by the video signal frame rate.

### Second Embodiment

In the first embodiment, a method of generating acoustic signal blocks in this embodiment has been described. In the second embodiment, a method of searching for a target acoustic signal block among accumulated acoustic signal blocks will be described. In the present embodiment, descriptions will be given mainly of differences from the first embodiment. Portions not particularly specified are the same configuration and processing as the first embodiment and a description of such portions will be omitted.

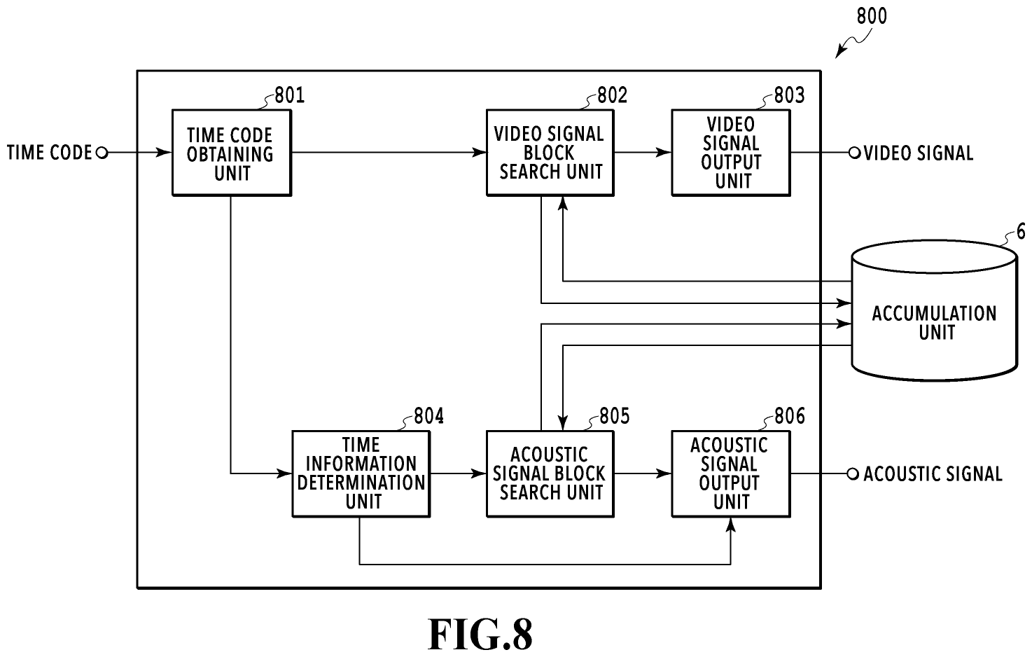

FIG. 8 shows an example of the functional configuration of a video and acoustic signal blocks search apparatus 800 (hereinafter referred to as the blocks search apparatus) that is an information processing apparatus in the present embodiment. The blocks search apparatus 800 according to the present embodiment functions as an acoustic signal block search apparatus that searches for an acoustic signal block and a video signal block search apparatus that searches for a video signal block.

A time code obtaining unit 801 obtains a time code interval that is a search target interval. More specifically, the time code obtaining unit 801 obtains a search start time code and a search end time code. Regarding search target time codes, instructions thereon are provided by a user via an operation unit of the blocks search apparatus 800. Alternatively, instructions on the search target time codes are provided by another program under execution in a CPU of the blocks search apparatus 800.

A video signal block search unit 802 performs a search of the accumulation unit 6 by using, as search values, the time codes obtained by the time code obtaining unit 801 and outputs a video signal block obtained as a search result to a video signal output unit 803. The video signal output unit 803 outputs a video signal stored in the obtained video signal block.

A time information determination unit 804 functions as a time conversion unit that converts each of the search target time codes obtained by the time code obtaining unit 801 into acoustic signal block time. Additionally, the time information determination unit 804 functions as an offset determination unit that determines an offset for outputting acoustic signal samples from the search target time codes as described later.

An acoustic signal block search unit 805 performs a search of the accumulation unit 6 by using, as search values, the time codes obtained by the time code obtaining unit 801 or acoustic signal block time and outputs an acoustic signal block obtained as a search result to an acoustic signal output unit 806. The acoustic signal output unit 806 outputs, based on the offset, acoustic signal samples stored in the obtained acoustic signal block.

As described above, based on input of the time codes, a video signal corresponding to the time codes and an acoustic signal corresponding to the time codes are outputted together.

The accumulation unit 6 is for the blocks generation apparatus 100 and stores video signal blocks and acoustic signal blocks generated by the blocks generation apparatus 100.

A description will be given on the premise that the blocks search apparatus 800 and the blocks generation apparatus 100 are configured by the same apparatus. The functions of the individual units in FIG. 8 are achieved by the CPU 102 of FIG. 1 reading out, into the RAM 103, program code stored in the ROM 107 or an external storage apparatus and executing the program code. Alternatively, some or all of the functions of the individual units in FIG. 8 may be achieved by using hardware such as an ASIC or electronic circuit.

Incidentally, as described later, the blocks search apparatus 800 and the blocks generation apparatus 100 may be different apparatuses and may be configured to be connected to each other via a network.

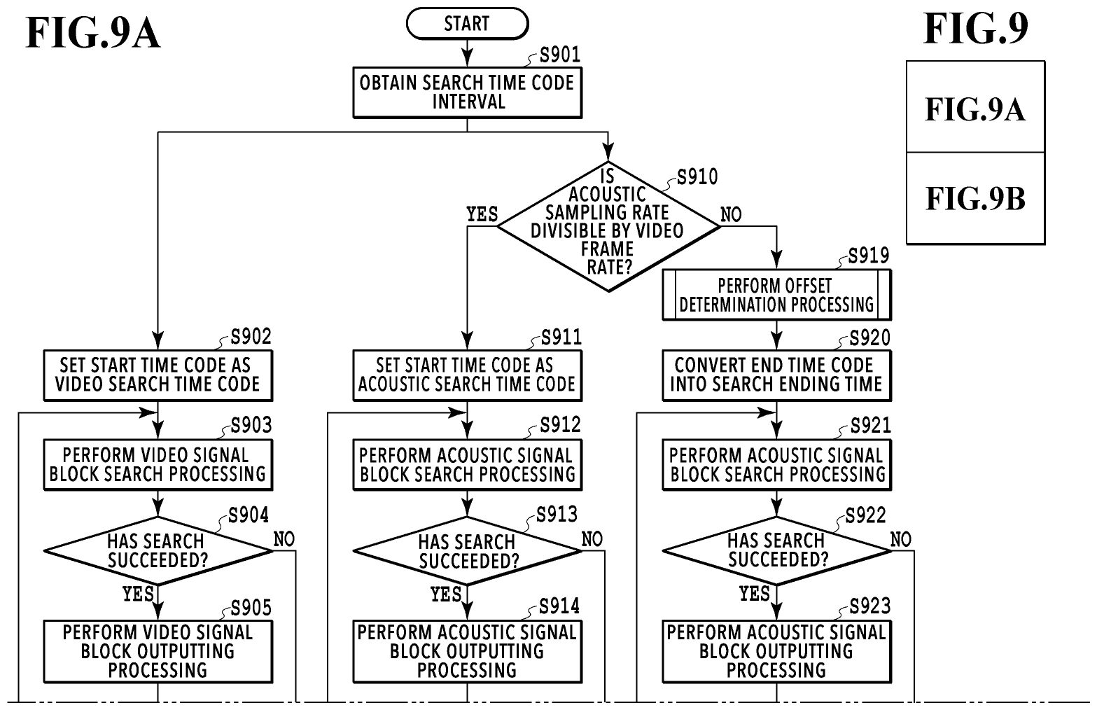

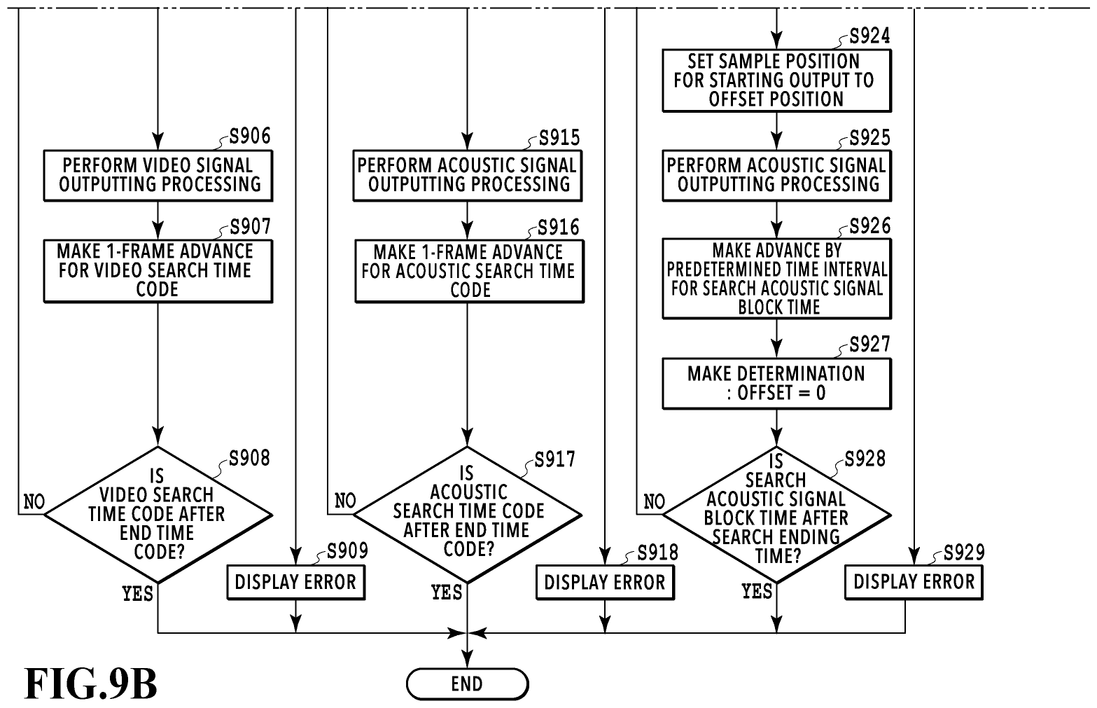

FIG. 9 is a flowchart of processing of searching for video and acoustic signal blocks in the present embodiment. Details of the processing of searching for video and acoustic signal blocks in the present embodiment will be described according to the present flowchart.

In S901, the time code obtaining unit 801 obtains a search start time code (start time code) and a search end time code (end time code). The obtained start time code and end time code are outputted to the video signal block search unit 802 and the video signal output unit 803.

Processing of S902 to S909 is processing of searching for a video signal block. Additionally, processing of S910 to S929 is processing of searching for an acoustic signal block. In the present embodiment, a description will be given on the premise that processing of searching for a video signal and processing of searching for an acoustic signal are executed in parallel.

First, video signal search processing (S902 to S909) will be described. In S902, the video signal block search unit 802 sets the start time code obtained in S901 as a video search time code. More specifically, the video signal block search unit 802 secures an area for storing the video search time code on the RAM 103 and copies the value of the start time code into the area.

In S903, the video signal block search unit 802 uses the video search time code as a search value to perform a search among the video signal blocks stored in the accumulation unit 6.

In S904, the video signal block search unit 802 determines whether the search has succeeded. In a case where the search has failed (NO in S904), the procedure advances to S909 and the CPU 102 causes the display unit 106 to display an error and ends the video block search processing. In a case where the search has succeeded, the procedure advances to S905.

In S905, the video signal block search unit 802 obtains a video signal block for which the search has been performed in S903 and outputs the video signal block to the video signal output unit 803. In S906, the video signal output unit 803 outputs, from a video output terminal of the blocks search apparatus 800, a video signal stored in the video signal block for which the search has been performed.

In S907, the video signal block search unit 802 makes a 1-frame advance for the video search time code stored on the RAM 103.

In S908, the video signal block search unit 802 determines whether the video search time code on the RAM 103 represents time after the end time code obtained in S901. In a case where the video search time code does not represent time after the end time code, the procedure returns to S903 and processing for a subsequent video search time code is continued. That is, processing of S903 to S908 is performed until the video search time code matches the end time code and then a video signal at the end time code is outputted. In a case where the video search time code on the RAM 103 is after the end time code, the processing is ended.

Next, acoustic signal search processing (S910 to S929) will be described. In S910, it is determined whether the acoustic sampling rate is divisible by the video frame rate.

In a case where the sampling rate is divisible by the frame rate (YES in S910), acoustic signal blocks are generated in the frame time unit. Thus, the procedure advances to S911 to perform processing for searching for an acoustic signal block in the frame time unit in S911 to S918. In a case where the sampling rate is not divisible by the frame rate (NO in S910), acoustic signal blocks are generated in the predetermined time interval unit. Thus, in S919 to S929, processing for searching for an acoustic signal block in the predetermined time interval unit is performed. First, the processing for searching for an acoustic signal block in the frame time unit will be described.

In a case of YES in S910, the video signal output unit 803 sets the start time code obtained in S901 as an acoustic search time code in S911. More specifically, the video signal output unit 803 secures an area for storing the acoustic search time code on the RAM 103 and copies the value of the start time code into the area.

In S912, the acoustic signal block search unit 805 uses the acoustic search time code on the RAM 103 as a search value to perform a search among the acoustic signal blocks stored in the accumulation unit 6. That is, the acoustic signal block search unit 805 searches for an acoustic signal block wherein a time code stored in the time information of the acoustic signal block is the acoustic search time code.

In S913, the acoustic signal block search unit 805 determines whether the search has succeeded. In a case where the search has failed, the procedure advances to S918 and the CPU 102 causes the display unit 106 to display an error and ends the acoustic signal block search processing. In a case where the search has succeeded, the procedure advances to S914.

In S914, the acoustic signal block search unit 805 obtains the acoustic signal block for which the search has been performed and outputs the acoustic signal block to the acoustic signal output unit 806. In S915, the acoustic signal output unit 806 obtains the acoustic signal block and outputs acoustic signal samples stored in the acoustic signal block to an acoustic output terminal. In S916, the acoustic signal block search unit 805 makes a 1-frame advance for the acoustic search time code on the RAM 103.

In S917, the acoustic signal block search unit 805 determines whether the acoustic search time code on the RAM 103 represents time after the end time code. In a case where the acoustic search time code is not after the end time code, the procedure returns to S912. Subsequently, processing of S912 to S917 is performed until an acoustic search time code matches the end time code and an acoustic signal sample at the end time code is outputted. In a case where the acoustic search time code is after the end time code in S917, the processing is ended.

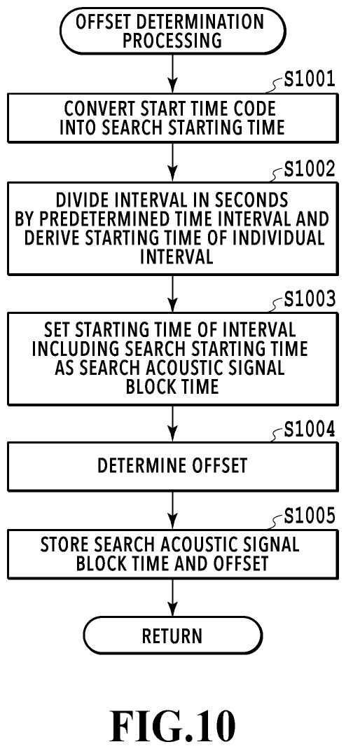

Next, a description will be given of processing in a case where the acoustic signal sampling rate is not divisible by the video signal frame rate (NO in S910). In S919, processing of determining search acoustic signal block time and an offset is performed based on the start time code obtained in S901. Details of this processing will be described using FIG. 10.

FIG. 10 is a flowchart for illustrating the details of the processing of determining search acoustic signal block time and an offset in S919. Processing in an individual step of the present flowchart is executed by the time information determination unit 804.

In S1001, the time information determination unit 804 performs processing of converting a time code into search time. More specifically, the time information determination unit 804 converts the start time code into time T. The time obtained by the conversion is referred to as search starting time Ta. The conversion method is the same as the method of converting a time code into time in S407.

For example, it is assumed that the start time code is obtained as 01:23:45:06. In this case, the time 01:23′46″626626627 obtained by the conversion using expression (2) in the first embodiment is determined as search starting time Ta.

In S1002, the time information determination unit 804 divides the time in seconds of the search starting time Ta by the predetermined time interval used to determine the sample number in S406. Subsequently, the time information determination unit 804 derives individual starting time of an individual interval obtained by the division. For example, in a case where the predetermined time interval is an interval of 1/20 second and the search starting time Ta is 01:23′46″626626627, 46 seconds, which has the second unit, is used to divide an interval of 1 second from a base point of 46.00 seconds into 20 parts and derive starting time of an individual interval.

In S1003, the time information determination unit 804 sets, among the intervals obtained by the division in S1002, starting time of an interval including the search starting time Ta as search acoustic signal block time Tk. Details of the processing are the same as those of the processing of setting the acoustic signal block time in S409.

For example, in a case where the predetermined time interval is set as an interval of 1/20 second (50 milliseconds) as shown in FIG. 5, 01:23′46″626626627, which is the search starting time Ta, is included in an interval having 46″60 as starting time. Thus, 01:23′46″60 is set as search acoustic signal block time Tk. That is, the time of the time information of an acoustic signal block including the search starting time, which is time obtained by converting the start time code, is set as the search acoustic signal block time Tk.

In S1004, the time information determination unit 804 determines an “offset” for determining an acoustic signal sample at the time of the head of the start time code. For example, the search acoustic signal block time Tk is subtracted from the search starting time Ta to derive the number of seconds St. The seconds St is the number from the search acoustic signal block time Tk to the search starting time Ta which is the head of the start time code. In a case where the search starting time Ta is 01:23′46″626626627 and the search acoustic signal block time Tk is 01:23′46″60, the number of seconds St is derived as follows:

St=01:23′46″626626627−01:23′46″60=0″026626627 [second] (3).

Next, the number of seconds St is multiplied by the acoustic signal sampling rate, followed by a round-off operation for a number after the decimal point. The obtained value is determined as an “offset”. For example, in a case where the number of seconds St is the value shown in expression (3) and the acoustic signal sampling rate is 48,000 Hz, the offset is determined as 1278.

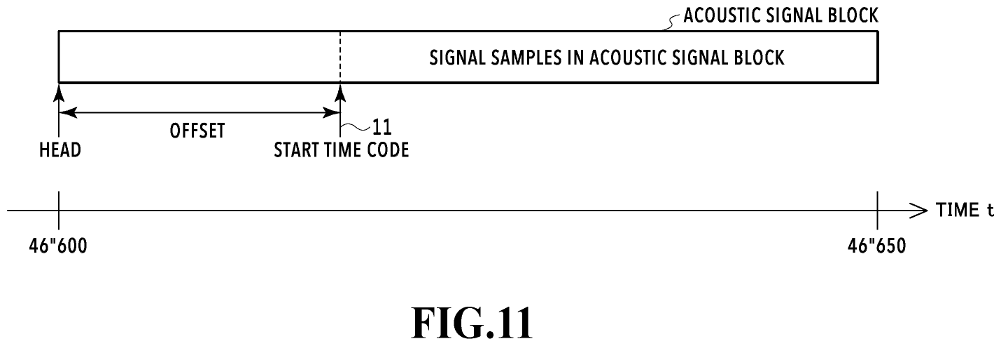

FIG. 11 is a schematic diagram of the acoustic signal data area of an acoustic signal block. A relationship between the start time code and the offset will be described with reference to FIG. 11. Incidentally, in FIG. 11, it is assumed that acoustic signal samples for a single channel are stored in order to simplify the description. In FIG. 11, the acoustic signal samples are stored in the acoustic signal data area of the acoustic signal block from left to right in chronological order in terms of time. It is assumed that an acoustic signal sample at the head of the start time code, that is, at the search starting time Ta, is located at a position indicated by up arrow 11 in the figure. In this case, the offset corresponds to the number of samples in an interval from the head sample of the acoustic signal block in which the search acoustic signal block time Tk is stored as time information to a sample indicated by up arrow 11.

In S1005, the time information determination unit 804 stores the search acoustic signal block time Tk determined in S1003 and the offset in a specified area on the RAM 103. Upon completion of the processing, the processing of the present flowchart is ended and the procedure advances to S920.

Returning to FIG. 9, the acoustic signal block search processing will be continuously described. In S920, the time information determination unit 804 performs processing of converting the end time code obtained in S901 into time T to derive search ending time. The conversion method is the same as the processing of deriving the search starting time in S1001 and therefore, a description thereof will be omitted. The search ending time is stored in an area secured on the RAM 103.

In S921, the acoustic signal block search unit 805 uses the search acoustic signal block time Tk on the RAM 103 as a search value to perform a search among the acoustic signal blocks stored in the accumulation unit 6. That is, the acoustic signal block search unit 805 searches for an acoustic signal block wherein time stored in the time information of the acoustic signal block is the search acoustic signal block time Tk.

In S922, the acoustic signal block search unit 805 determines whether the search in S921 has succeeded. In a case where the search has failed, the CPU 102 causes the display unit 106 to display an error in S929 and ends the acoustic signal block search processing. In a case where the search has succeeded as a result of the determination, the procedure advances to S923.

In S923, the acoustic signal block search unit 805 outputs the acoustic signal block for which the search has been performed in S921 to the acoustic signal output unit 806.

In S924, the acoustic signal output unit 806 determines an output starting position for acoustic signal data in the acoustic signal block. The output starting position is set to an acoustic signal sample derived from a backward shift by the offset from the head acoustic signal sample of the acoustic signal block outputted to the acoustic signal output unit 806 in S923. By setting the output starting position based on the offset in this way, an acoustic signal can be outputted from the acoustic signal sample at the head of the start time code.

In S925, the acoustic signal output unit 806 outputs acoustic signal samples stored in the acoustic signal block that is an output target from the output starting position to the last. That is, in a case where the offset is not 0, the acoustic signal output unit 806 outputs acoustic signal samples from an acoustic signal sample derived from a shift by the offset from the head of the acoustic signal block to the last acoustic signal sample. Additionally, in a case where the offset is 0, the acoustic signal output unit 806 outputs acoustic signal samples from the head of the acoustic signal block to the last.

In S926, the acoustic signal block search unit 805 makes an advance for the search acoustic signal block time on the RAM 103 by the predetermined time interval used to determine the sample number in S406.

In S927, the acoustic signal block search unit 805 changes the offset stored on the RAM 103 to 0. By changing the offset to 0, in a case where acoustic signal samples are continuously outputted, acoustic signal samples stored in a subsequent acoustic signal block are outputted from the head to the last. Thus, acoustic signal samples can be outputted without a pause.

In S928, the acoustic signal block search unit 805 determines whether the search acoustic signal block time on the RAM 103 represents time after the search ending time. In a case where the search acoustic signal block time does not represent time after the search ending time as a result of the determination, the procedure returns to S921 to perform processing of S921 to S928. In a case where the search acoustic signal block time on the RAM 103 is after the search ending time, the processing is ended.

As described above, the present embodiment makes it possible to search for and output acoustic signal samples corresponding to time codes on which search instructions have been provided even in a case where acoustic signal blocks are generated in a predetermined time interval unit.

Incidentally, in the above description, search target time codes are obtained in an interval from start to end; however, time codes for which a search is to be performed may be sequentially obtained one by one. Additionally, it is possible to obtain a start time code alone and search for a block to output a block signal until the user's end instructions arrive.

It is also possible to add the function of outputting, according to a timing that acoustic signal samples are outputted, a video signal corresponding to the time code or acoustic signal block time. This function enables synchronization between an acoustic signal outputted by the acoustic signal output unit and a video signal outputted by the video signal output unit.

### Other Embodiments

In the above-described embodiments, all acoustic signal blocks store header information, for example, the number of channels, a sampling rate, and a sample format; however, the configuration of an acoustic signal block is not limited to this. For example, in a case where these pieces of header information are predetermined definitively and are not changed in the entire processing performed by a signal processing apparatus, it is possible to prestore the header information other than time information in the RAM 103 or ROM 107 and store the time information alone in the header information of an acoustic signal block. This makes it possible to reduce the size of the entire acoustic signal block and more effectively utilize the storage area of the accumulation unit 6.

In the above-described embodiments, the description has been given on the premise that the blocks generation apparatus 100 and the blocks search apparatus 800 are the same apparatuses; however, the blocks generation apparatus 100 and the blocks search apparatus 800 may be different apparatuses. That is, the blocks generation apparatus 100 may transmit generated video signal blocks and acoustic signal blocks via a network to the blocks search apparatus 800.

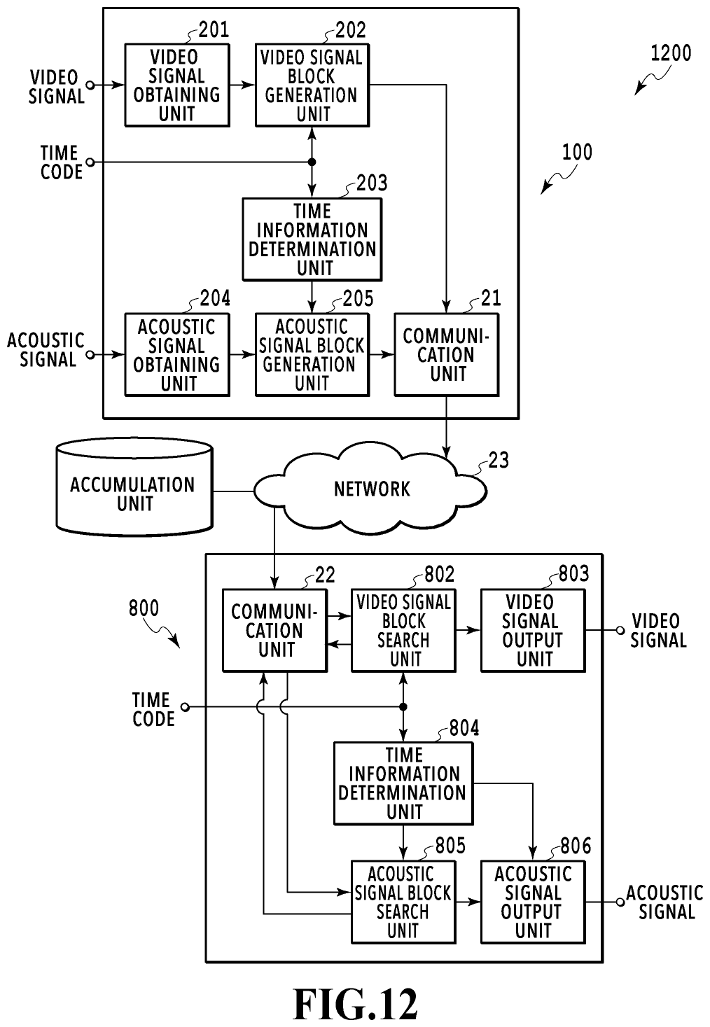

FIG. 12 shows an example of the functional configuration of a blocks generation system 1200 in a case where the blocks generation apparatus 100 and the blocks search apparatus 800 are configured by different apparatuses. For the same processing blocks as the above-described embodiments, the same reference numerals will be used and a description thereof will be omitted.

Communication units 21 and 22 are each used to connect a network 23 and an apparatus. It is possible to transmit/receive video signal blocks and acoustic signal blocks via the communication units 21 and 22 from the blocks generation apparatus 100 to the blocks search apparatus 800. Thus, the blocks generation system 1200 also makes it possible to search for, based on time codes, a video signal block and an acoustic signal block generated by the blocks generation apparatus 100 and output acoustic signal samples as in the second embodiment.

Additionally, an accumulation unit may be included in either the blocks generation apparatus 100 or the blocks search apparatus 800. Alternatively, the accumulation unit may be connected on the network as an apparatus different from the blocks generation apparatus 100 or the blocks search apparatus 800 as shown in FIG. 12.

The above-described embodiments can be used for all applications that include providing, in a block form, a video signal and an acoustic signal together with time information, followed by accumulation, a search, and transmission. More specifically, the embodiments can be used as video and acoustic streams, a data format for video and acoustic media, and a data format for an accumulation and transmission system of a video and acoustic communication system, and a method of handling them.

In the above-described embodiments, the description has been given mainly of a case where the video signal frame rate is 29.97 fps and the acoustic signal sampling rate is 48 kHz; however, the frame rate and the sampling rate are not limited to these values. For example, the video signal frame rate may be a multiple of 29.97 fps and the acoustic signal sampling rate may be a multiple of 48 kHz.

The technique in the present disclosure can reduce the processing load of acoustic processing.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-161285, filed Sep. 4, 2019, which is hereby incorporated by reference wherein in its entirety.

What is claimed is:

1. An information processing apparatus comprising:
an information obtaining unit configured to obtain information indicating a time code of a processing target video frame included in video data that is in accordance with a specific frame rate;
a specifying unit configured to specify an acoustic signal block corresponding to the obtained time code among a plurality of acoustic signal blocks each of which collectively includes a fixed number of successive acoustic samples, the successive acoustic samples being included in acoustic data that is in accordance with a specific sampling rate, wherein a time interval corresponding to one video frame is different from a time interval corresponding to one acoustic signal block; and
a processing unit configured to associate acoustic samples included in the specified acoustic signal block with the video frame corresponding to the obtained time code to perform processing.

2. The information processing apparatus according to claim 1, wherein
the specifying unit converts the obtained time code into time information and specifies, as the acoustic signal block corresponding to the time code, an acoustic signal block corresponding to a period including time indicated by the time information.

3. The information processing apparatus according to claim 1, wherein
the processing unit determines an offset depending on a difference between time indicated by time information and starting time of a period corresponding to the specified acoustic signal block and associates the video frame corresponding to the obtained time code with acoustic samples specified based on the determined offset among the acoustic samples included in the specified acoustic signal block to perform the processing.

4. The information processing apparatus according to claim 1, wherein
the processing by the processing unit comprises processing of outputting an acoustic signal depending on the acoustic samples included in the specified acoustic signal block together with a video signal depending on the video frame corresponding to the obtained time code.

5. The information processing apparatus according to claim 1, wherein
the processing by the processing unit comprises processing of associating an acoustic signal depending on the acoustic samples included in the specified acoustic signal block with a video signal depending on the video frame corresponding to the obtained time code and storing the acoustic signal and the video signal in a storage unit.

6. The information processing apparatus according to claim 1, wherein
the processing by the processing unit comprises processing of providing the specified acoustic signal block with information indicating starting time of a period corresponding to the acoustic signal block and storing the specified acoustic signal block in a storage unit.

7. The information processing apparatus according to claim 1, wherein
the processing by the processing unit comprises processing of providing the specified acoustic signal block with information indicating the obtained time code and storing the specified acoustic signal block in a storage unit.

8. The information processing apparatus according to claim 1, wherein
the specific sampling rate is not a multiple of the specific frame rate.

9. The information processing apparatus according to claim 1, wherein
the specific frame rate is a multiple of 29.97 fps, and
the specific sampling rate is a multiple of 48 kHz.

10. The information processing apparatus according to claim 1, wherein
the fixed number of samples does not depend on the specific frame rate.

11. The information processing apparatus according to claim 1, wherein
the time interval corresponding to the one acoustic signal block is a length obtained by dividing 1 second by an integer.

12. The information processing apparatus according to claim 1, wherein
the video data is obtained based on imaging of an imaging target region, and
the acoustic data is obtained based on sound collection in the imaging target region.

13. An information processing method comprising:
obtaining information indicating a time code of a processing target video frame included in video data that is in accordance with a specific frame rate;
specifying an acoustic signal block corresponding to the obtained time code among a plurality of acoustic signal blocks each of which collectively includes a fixed number of successive acoustic samples, the successive acoustic samples being included in acoustic data that is in accordance with a specific sampling rate, wherein a time interval corresponding to one video frame is different from a time interval corresponding to one acoustic signal block; and
associating acoustic samples included in the specified acoustic signal block with the video frame corresponding to the obtained time code to perform processing.

14. The information processing method according to claim 13, further comprising:
converting the obtained time code into time information, wherein
an acoustic signal block corresponding to a period including time indicated by the time information is specified as the acoustic signal block corresponding to the time code.

15. The information processing method according to claim 13, further comprising:
determining an offset depending on a difference between time indicated by time information and starting time of a period corresponding to the specified acoustic signal block, wherein
the video frame corresponding to the obtained time code is associated with acoustic samples specified based on the determined offset among the acoustic samples included in the specified acoustic signal block to perform the processing.

16. A non-transitory computer readable storage medium storing a program which causes a computer to perform an information processing method comprising:
obtaining information indicating a time code of a processing target video frame included in video data that is in accordance with a specific frame rate;
specifying an acoustic signal block corresponding to the obtained time code among a plurality of acoustic signal blocks each of which collectively includes a fixed number of successive acoustic samples, the successive acoustic samples being included in acoustic data that is in accordance with a specific sampling rate, wherein a time interval corresponding to one video frame is different from a time interval corresponding to one acoustic signal block; and
associating acoustic samples included in the specified acoustic signal block with the video frame corresponding to the obtained time code to perform processing.
